(19) United States
(12) Patent Application Publication
(10) Pub. No.: US 2024/0407313 A1
(43) Pub. Date: Dec. 12, 2024

(54) GROWING SYSTEM

(71) Applicant: Green Planet Group, Inc., Tempe, AZ (US)

(72) Inventors: Edmond Lonergan, Tempe, AZ (US); James Schoenberger, Tempe, AZ (US)

(21) Appl. No.: 18/739,105

(22) Filed: Jun. 10, 2024

Related U.S. Application Data
(60) Provisional application No. 63/507,193, filed on Jun. 9, 2023.

(51) Int. Cl. A01G 31/04; A01G 7/04; A01G 27/00

(52) U.S. Cl. CPC A01G 31/042; A01G 7/045; A01G 27/001

(57) ABSTRACT

Disclosed is an apparatus for growing plants that includes a conveyor and trays for containing seeds and/or plants. The trays with seeds and/or plants are conveyed by the conveyor through a growing environment. The conveyor is covered by a hood, which isolates the growing environment between the hood and the conveyor. The growing environment provides resources each plant needs to grow from seed to ready-to-harvest plant, without relying on the sun, rain, or ground. The conveyor includes a seed end and a harvest end. Each tray, filled with seeds at the seed end, moves from the seed end to the harvest end along the conveyor, through the growing environment. Along the way, seeds sprout and grow into mature plants ready for harvesting. When the tray reaches the harvest end, the plants are removed from the plant tray and are ready for consumption.

### CROSS REFERENCE TO RELATED APPLICATION[S]

This application claims priority to U.S. Provisional Patent Application entitled “GROWING SYSTEM,” Ser. No. 63/507,193, filed Jun. 9, 2023, the disclosure of which is hereby incorporated entirely herein by reference.

### BACKGROUND OF THE INVENTION

### Technical Field

This invention relates to plant growing and harvesting equipment, and specifically to a conveyor system for growing plants.

### State of the Art

Plants are grown as crops for many reasons. Plants are grown as food for humans and animals, as well as to use for bedding, for fuel, for ornament, or for housing. Plant crops are usually grown outdoors on plots of land, or in green houses, with the sun providing the light to the plants. Water is provided by rain or by irrigation systems that carry stored water to the crops. Many plant crops are grown some distance from where they will be consumed, often because land for growing crops is cheaper farther away from population centers. The cost of transporting seeds and harvested plants, as well as the cost of the land the plants are grown on, can add significantly to the cost of the crops grown. In addition, there is much waste of water and fertilizer resources when growing plants in the ground, which further increases the cost of the plant crop. Crops grown in the ground are subject to the vagaries of weather and often do not grow and mature optimally—or at all—due to weather conditions.

Accordingly, what is needed is an apparatus for growing plants that provides optimal environmental conditions for plant growth, that does not rely on the sun or outdoor growing conditions to create these environmental conditions, and that can be used to grow plants when and where they are needed.

### BRIEF DESCRIPTION OF THE DRAWINGS

FIG. 1 shows a pictorial representation of a plant growing apparatus;

FIG. 2 shows a perspective view of a portion of a plant growing apparatus;

FIG. 3 shows a side view of a portion of a plant growing apparatus, with the hood sides removed;

FIG. 4 shows a side view of a portion of a plant growing apparatus, with the hood sides intact;

FIG. 5 shows a side view of a portion of a plant growing apparatus that includes a sterilizing tray;

FIG. 6 shows a top perspective view of a tray;

FIG. 7 shows a top view of the tray of FIG. 6;

FIG. 8 shows a bottom view of the tray of FIG. 6;

FIG. 9 shows a side view of the tray of FIG. 6;

FIG. 10 shows an end view of the tray of FIG. 6;

FIG. 11 shows a perspective view of a conveyor guide fin;

FIG. 12 shows an end view of two trays coupled together as they would be on conveyor 116;

FIG. 13 shows a side cross-section of the two trays of FIG. 12 coupled together;

FIG. 14 shows a top perspective view of a portion of the two trays of FIG. 12 coupled together;

FIG. 15 shows an expanded top perspective view of a portion of the two trays of FIG. 12 coupled together;

FIG. 16 shows an end view of a portion of a tray and a side panel;

FIG. 17 shows a top view perspective of a conveyor;

FIG. 18 shows a side view of a portion of the conveyor of FIG. 17;

FIG. 19 shows a side view of a power tray and a plant tray; and

FIG. 20 illustrates a method 400 of growing plants.

### DETAILED DESCRIPTION OF EMBODIMENTS OF THE INVENTION

As discussed above, embodiments of the present invention relate to plant growing and harvesting equipment, and specifically to a conveyor system for growing plants.

Disclosed is an apparatus for growing plants that includes a conveyor and trays for containing the seeds/plants. The trays are conveyed by the conveyor through a growing environment. The growing environment provides resources plants need to grow from seed to ready-to-harvest plant, without relying on the sun, rain, or ground. The conveyor includes a seed end and a harvest end. Seeds are placed in a plant tray at the seed end. Each tray with its seeds moves from the seed end to the harvest end along the conveyor, through the growing environment. Along the way, the seeds sprout and grow into mature plants ready for harvesting. When the tray reaches the harvest end, the plants are removed from the plant tray and are ready for consumption. The empty tray is sterilized and brought back to the seed end to begin the process again.

The conveyor is covered by a hood, which isolates a growing environment between the hood and the conveyor. The growing environment envelopes the seeds and plants inside the trays. The growing environment includes light emitters to provide light rays to the plants and seeds, and a source of water that supplies water and plant fertilizer to the plants and seeds. The plant growing apparatus controls the temperature and humidity of the growing environment, and the amount and quality of light, water, and fertilizer that the seeds and plants receive. The plants move along the conveyor at a rate such that they are ready to be harvested when they reach the harvest end. The growing environment experienced by a particular tray can change as the tray moves along the length of the conveyor, so that at each stage in a seed or plant's life, it is enveloped by an optimum growing environment.

Plants grown by the disclosed plant growing apparatus receive the light, nutrients, and water needed to grow from seeds to mature healthy plants in a minimum amount of time and with no wasted resources such as water or fertilizer. The plant growing apparatus is placed near where the mature plants will be consumed, so that storage and transportation is minimized. The plant growing apparatus provides mature harvested plants as they are needed, in other words, each day's usage of plants may be harvested from the plant growing apparatus every day, with a minimum of shortage or overage, so that storage of harvested plants is unnecessary. The plant growing apparatus can be sized and shaped to provide harvested plants for a house, a store, a farm, or a city, consuming a minimum of resources and providing high quality harvested plants when and where they are needed.

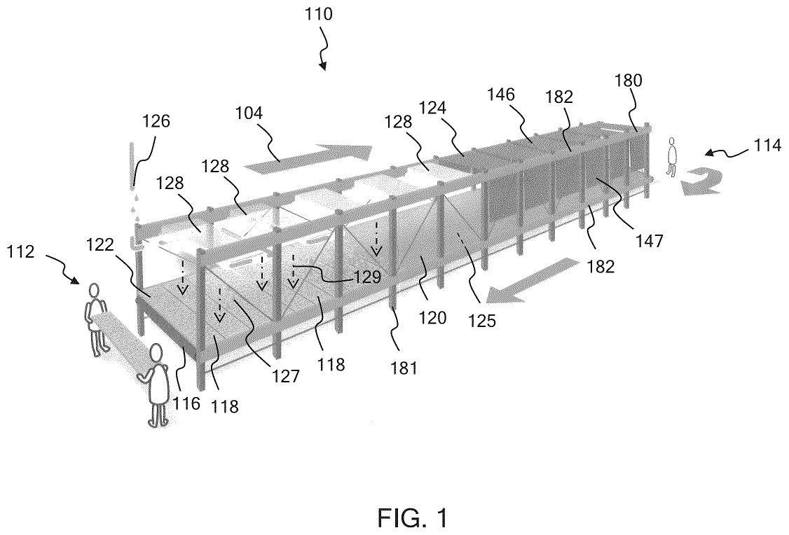

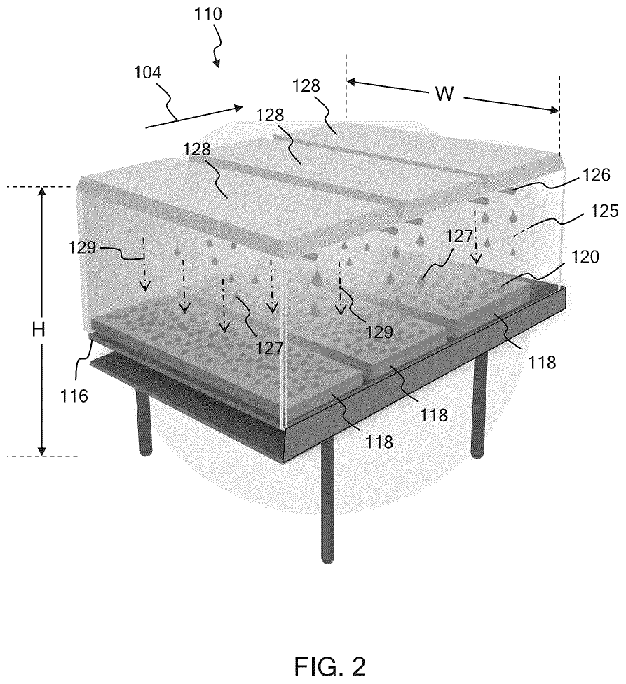

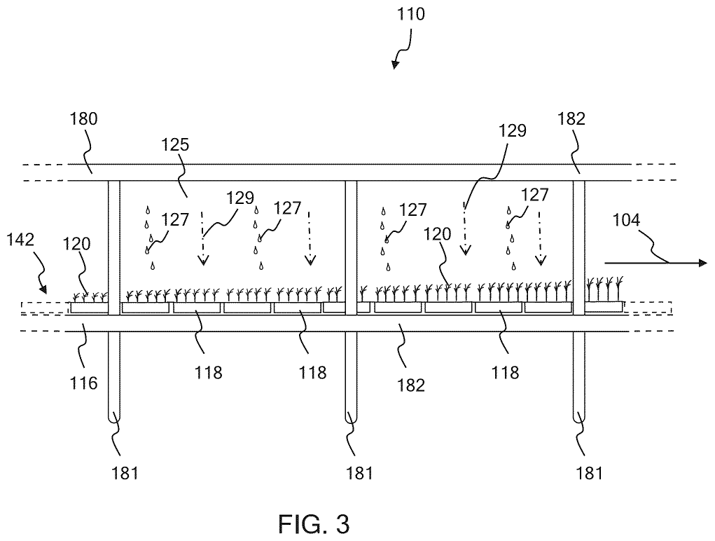

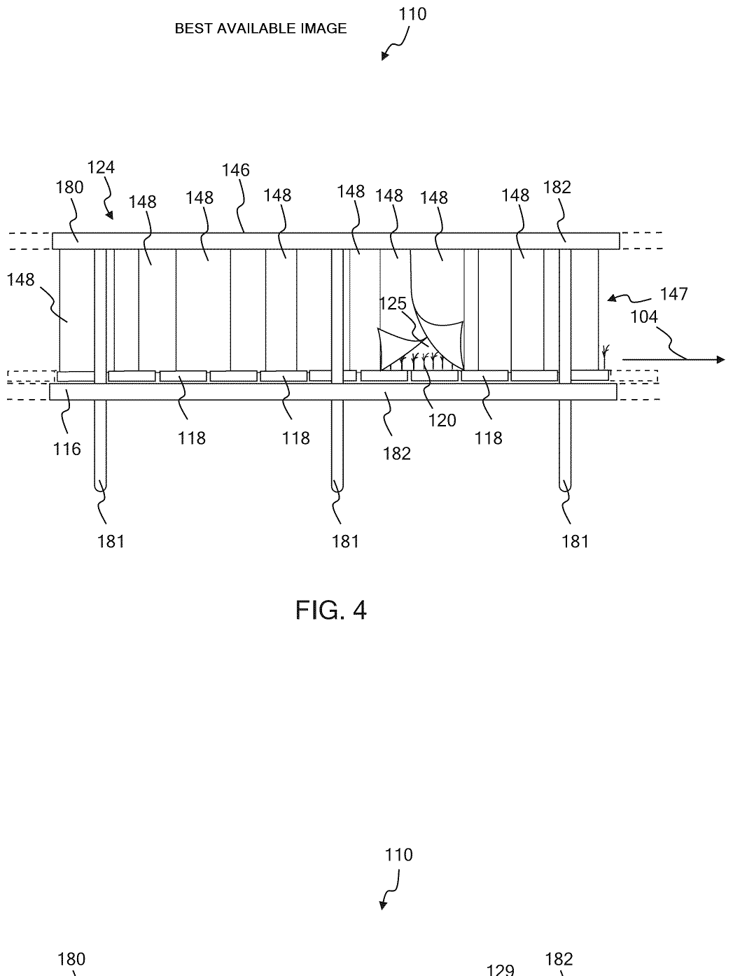

FIG. 1 through FIG. 4 show pictorial representations of a plant growing apparatus 110. FIG. 1 shows a pictorial representation of a plant growing apparatus 110. FIG. 2 shows a perspective view of a portion of plant growing apparatus 110. FIG. 3 shows a side view of a portion of plant growing apparatus 110, with hood sides 147 removed for simplicity. FIG. 4 shows a side view of the portion of plant growing apparatus 110 of FIG. 3, with hood sides 147 in place.

Plant growing apparatus 110 includes a conveyor 116 and a plurality of plant trays 118. In FIG. 1 through FIG. 4, only a portion of the trays 118 shown in the figure are labeled, for simplicity of the drawing. Conveyor 116 supports and conveys trays 118 on a top side 142 (FIG. 3) of conveyor 116 in a direction 104. Conveyor 116 can convey plants trays 118 along conveyor 116 in many different ways, including using a rolling belt conveyor, an automated conveyor, a manual driven conveyor, a weight- or water-driven conveyor, or any other method of conveying plant trays 118 along conveyor 116.

Each tray 118 holds seeds 122 and/or plants 120. Conveyor 116 includes a seed end 112 and a harvest end 114 (FIG. 1). Referring to FIG. 1, seed end 112 is the beginning of conveyor 116, where an empty tray 118 is filled with seeds 122 and loaded onto conveyor 116. Harvest end 114 is the end of conveyor 116, where each tray 118 is emptied of its plants 120 that have grown from seeds 122, and tray 118 is removed from conveyor 116. Conveyor 116 conveys trays 118 in direction 104 from seed end 112 to harvest end 114 of conveyor 116.

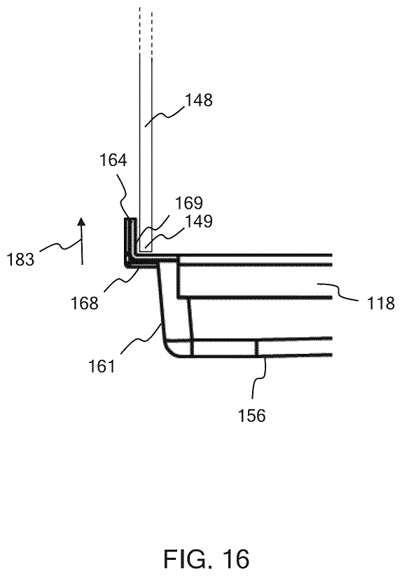

Conveyor 116 also includes a hood 124 (FIG. 1 and FIG. 4). Hood 124 covers top side 142 (FIG. 3) of conveyor 116 and contains a growing environment 125 between conveyor 116 and hood 124. Hood 124 is shown partially see-through in FIG. 1, for ease of seeing elements beneath hood 124. Hood 124 is not shown in FIG. 2 and FIG. 3, so that the elements beneath hood 124 can be seen. Hood 124 is shown in side view in FIG. 4. Hood 124 includes a hood top 146 (FIG. 1) and hood sides 147 (FIG. 1 and FIG. 4). Hood sides 147 can take many forms. In this embodiment, hood sides 147 include a plurality of individual panels 148 of flexible material. Panels 148 hang from hood top 146 and extend from hood top 146 to conveyor 116, confining growing environment 125 between hood 124 and conveyor 116. Using a plurality of panels 148 made from flexible material make it easier for a worker to access growing environment 125, trays 118, plants 120, or anything else inside growing environment 125. FIG. 4 shows two individual panels 148 folded back, illustrating how panels 148 can be moved and opened by a user to access growing environment 125 and plants 120 or seeds 122. Also see FIG. 16, which shows how hood guides 164 of trays 118 restrict hood side panels 148 from moving away from trays 118 when side panels 118 are hanging in their unopened position. Keeping side panels 148 from moving away from trays 118 helps to confine growing environment 125 between conveyor top side 142 and hood 124.

Seeds 122 placed in each tray 118 at seed end 112 are conveyed through growing environment 125 to harvest end 114. Hood 124 confines growing environment 125 between hood 124 and conveyor 116. Growing environment 125 encourages and supports seeds 112 to sprout and grow into plants 120 as trays 118 are conveyed through growing environment 125. As each tray 118 is conveyed from seed end 112 to harvest end 114, growing environment 125 provides the water, nutrients, light, and environment for seeds 122 to sprout and grow into plants 120. Once a tray 118 reaches harvest end 114, plants 120 are removed (harvested) from tray 118. Tray 118 is sterilized and returned to seed end 112 to begin the process again.

Plant growing apparatus 110 includes a plurality of growing light emitters 128 and a water delivery system 126 (FIG. 1 and FIG. 2). Growing light emitters 128 provides the light needed for plants 120 and seeds 122 to sprout and grow. Growing light emitters 128 emit growing light rays 129 (FIG. 1, FIG. 2, and FIG. 3, not all growing light rays are numbered) into growing environment 125 such that growing light rays 129 illuminate seeds 122 and plants 120 with growing light rays 129. Growing light emitters 128 are located inside growing environment 125 along conveyor 116, positioned such that a maximum of growing light rays 129 illuminate seeds 122 or plants 120. Growing light rays 129 are chosen to have wavelength, intensity and duration characteristics that supports the sprouting and growth of seeds 122 and plants 120. Growing light emitters 128 can be on—emitting light—all the time, or some of the time, according to the specific needs of the plants 120 or seeds 122 underneath each specific growing light emitter 128. The duration that any specific growing light emitter 128 is on can vary along conveyor 116. For example, seeds 122 may need more or less growing light 129 than plants 120. Plants 120 that have just sprouted may need more or less growing light 129 than plants 120 ready for harvest. Each growing light emitter 128 is programmed to turn on and off in intervals that are designed to best provide the growing light 129 duration and timing needed to the particular seeds 122 or plants 120 beneath each growing light emitter 128.

The wavelength and intensity of growing light rays 129 is similarly variable along conveyor 116, with variations introduced so that the plants 120 or seeds 122 in each tray 118 receive the wavelength and intensity of growing light rays 129 that is optimum for their specific stage of development along conveyor 116. Controlling the duration, wavelength, and intensity of growing light rays 129 that each tray 118 receives at each specific point along conveyor 116 results in optimum plant growth, with a minimum of energy wasted by growing light emitters 128.

The inner surfaces of hood 124 are coated to be reflective to growing light rays 129. This ensures a minimum of growing light rays 129 escape growing environment 125, and a maximum of growing light rays 129 are absorbed by seeds 122 or plants 120.

Water delivery system 126 provides water mixture 127 to plants 120. Water delivery system 126 is a system of water pipes and water emitters that carries water mixture 127 (water and fertilizer) from storage facilities that are outside growing environment 125 to seeds 122 or plants 120 inside growing environment 125. Water delivery system 126 is shown as dripping water mixture 127 onto plants 120 in trays 118, but this is not meant to be limiting. Water delivery system 126 can drip water mixture 127, spray water mixture 127, or provide any other way of delivering water mixture 127 to plants 120 or seeds 122. Water mixture 127 can include many different components, including but not limited to water, fertilizer, minerals, nutrients or other elements that seeds 122 or plants 120 may need for sprouting and growth. The amount of time that water delivery system 126 is delivering water mixture 127 to plants 120 or seeds 122 can vary along conveyor 116. The composition of water mixture 127 can also vary along conveyor 116. The timing of water delivery system 126 and composition of water mixture 127 varies along conveyor 116 so that the seeds 122 or plants 120 in each specific tray 118 receive the amount and composition of water mixture 127 needed at each specific stage of sprouting and growth, with little to no waste or lack. This ensures optimum seed sprouting and growth and minimum resource waste.

Plant growing apparatus 110 in the embodiment shown in FIG. 1 through FIG. 4 is supported by frame 180 (see FIGS. 1, 3, and 4). Frame 180 in this embodiment includes post 181 and beams 182. Frame 180 supports conveyor 116 and hood 124. It is to be understood that the structure of plant growing apparatus 110 can include many different features other than frame 180, and that frame 180 can take many different forms. In this embodiment frame 180 has a height H of about 8 feet above the ground, and a width W of about 8 feet (see FIG. 2).

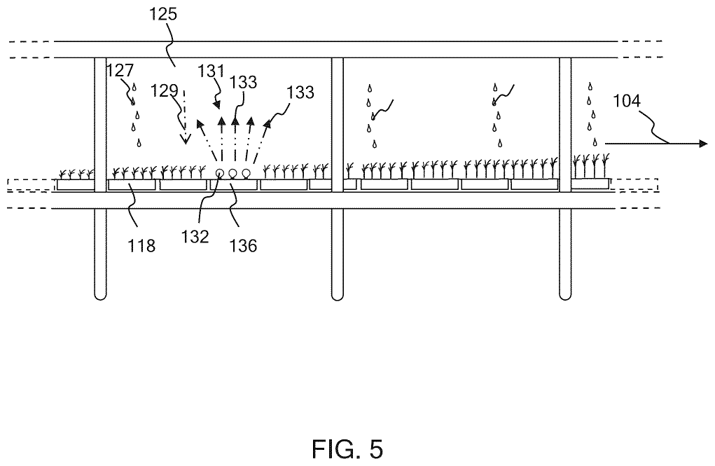

In some embodiments, plant growing apparatus 110 includes one or more sterilizing tray 136, as shown in FIG. 5. FIG. 5 shows a side view of a portion of plant growing apparatus 110 with hood sides 147 removed, showing a sterilizing tray 136 positioned on conveyor 116 between two trays 118. Sterilizing tray 136 sets on conveyor 116, and is conveyed through growing environment 125 from seed end 112 to harvest end 114. Sterilizing tray 136 is positioned between trays 118 being conveyed along conveyor 116. In some embodiments, there is more than one sterilizing tray 136 along conveyor 116. Sterilizing tray 136 includes a sterilizing system 131. Sterilizing system 131 sterilizes growing environment 125 as conveyor 116 conveys sterilizing tray 136 from seed end 112 to harvest end 114. Sterilizing means to eliminate unwanted fungus, bacteria, viruses, or other unwanted growths. Sterilizing system 131 can include many different types of sterilizing devices. In this embodiment, sterilizing system 131 includes sterilizing light emitters 132, which emit sterilizing light rays 133. Sterilizing light rays 133 of sterilizing system 131 sterilize growing environment 125 as sterilizing tray 136 is conveyed through growing environment 125. Sterilizing light rays 133 are often light rays in the ultraviolet portion of the spectrum, but this is not meant to be limiting. In some embodiments, sterilizing system 131 sprays sterilizing liquid into growing environment 125 to sterilize growing environment 125. Sterilizing tray 136 can sterilizer growing environment 125, tray 118, hood 124, growing light emitters 128, or any other part of plant growing apparatus 110.

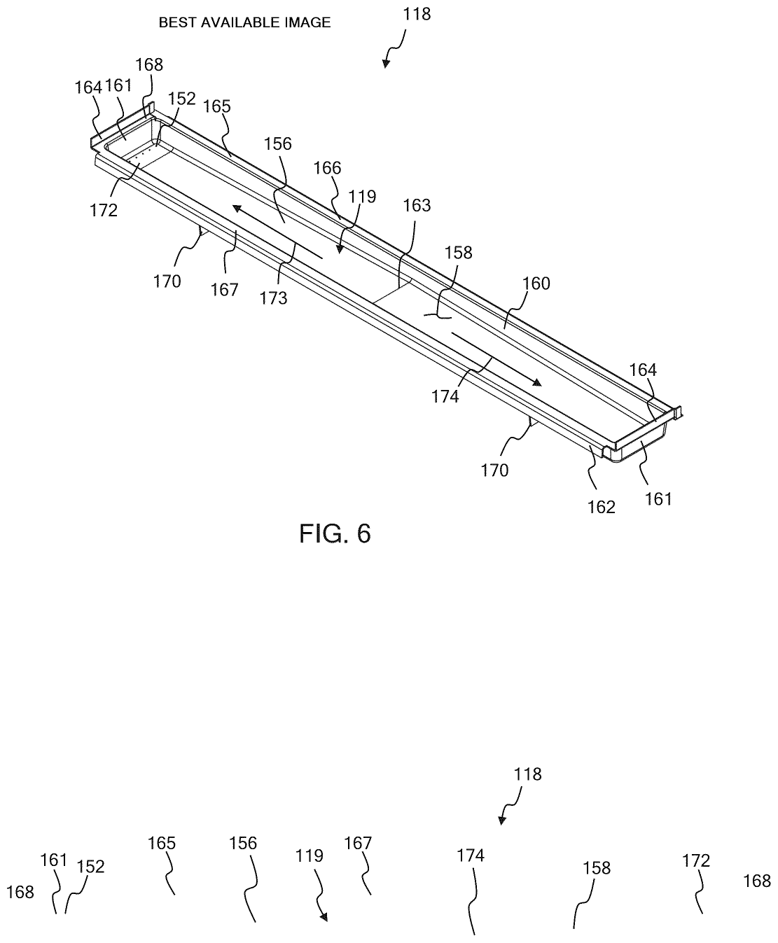

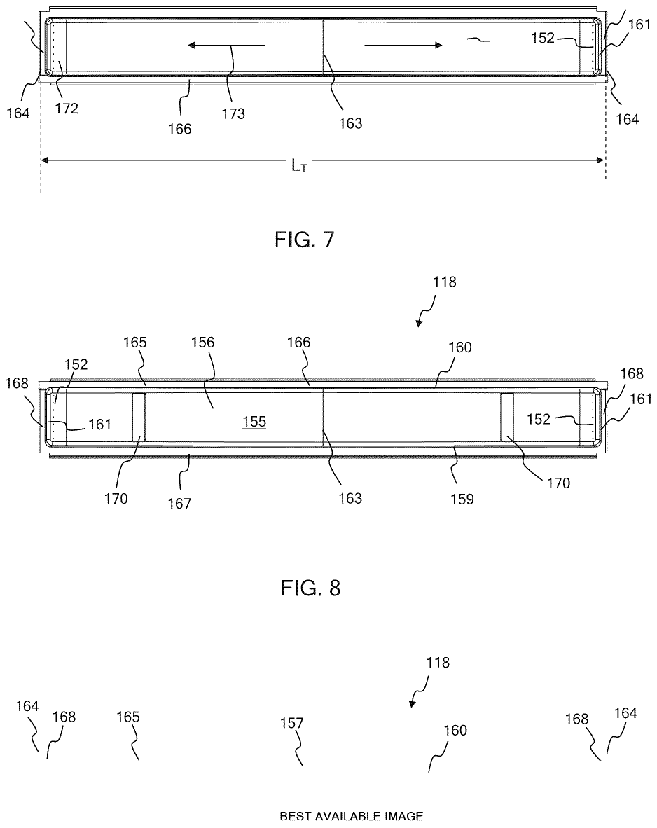

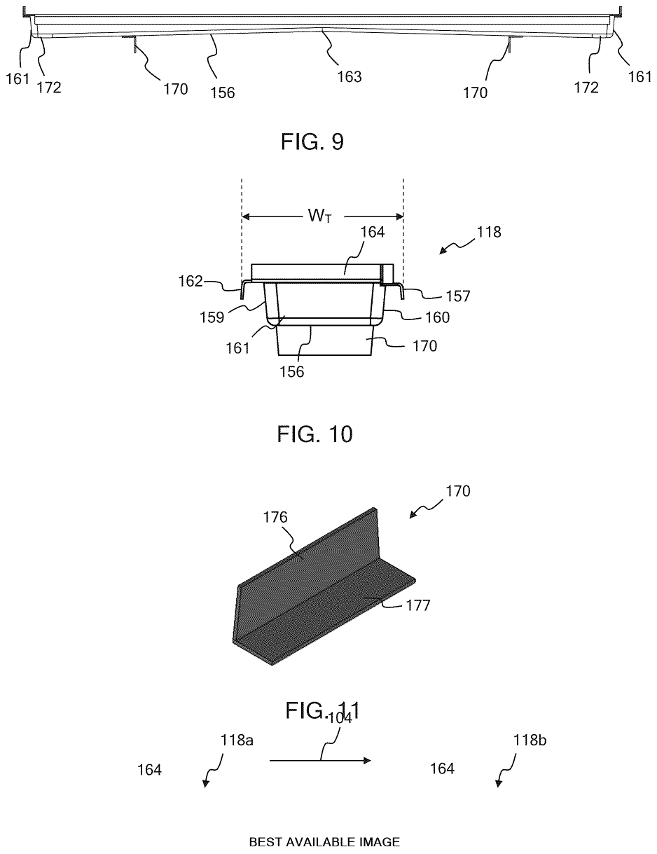

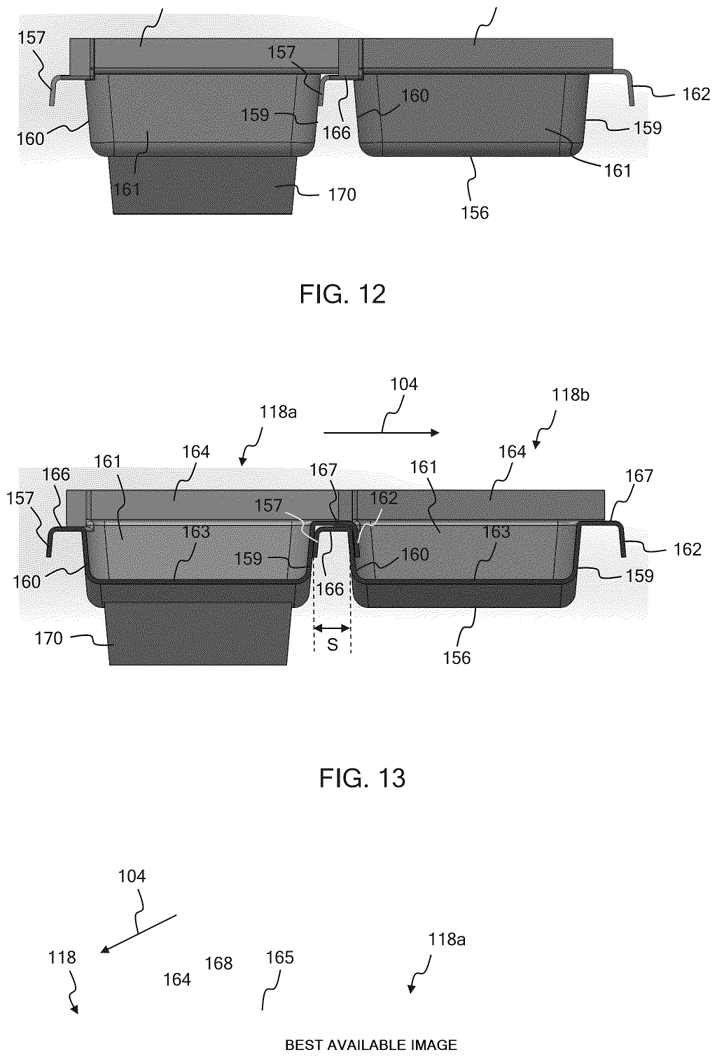

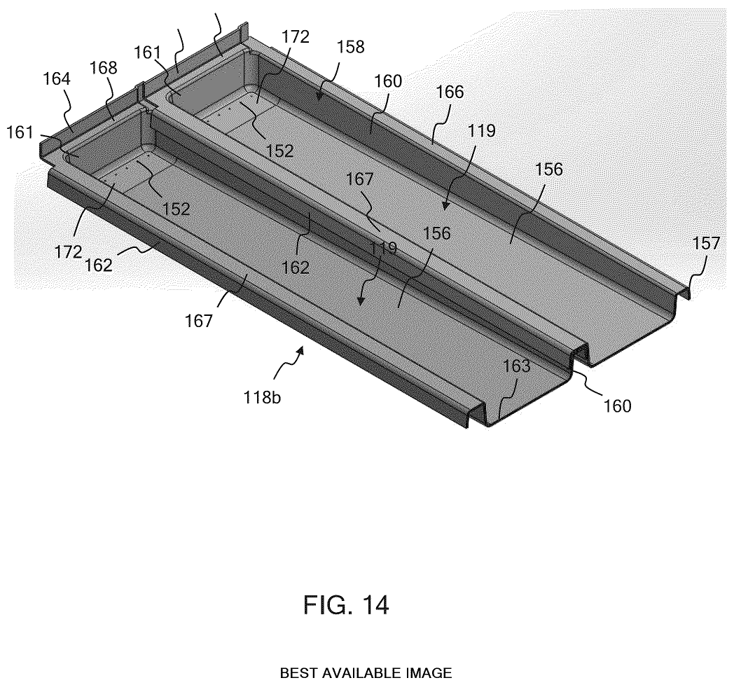

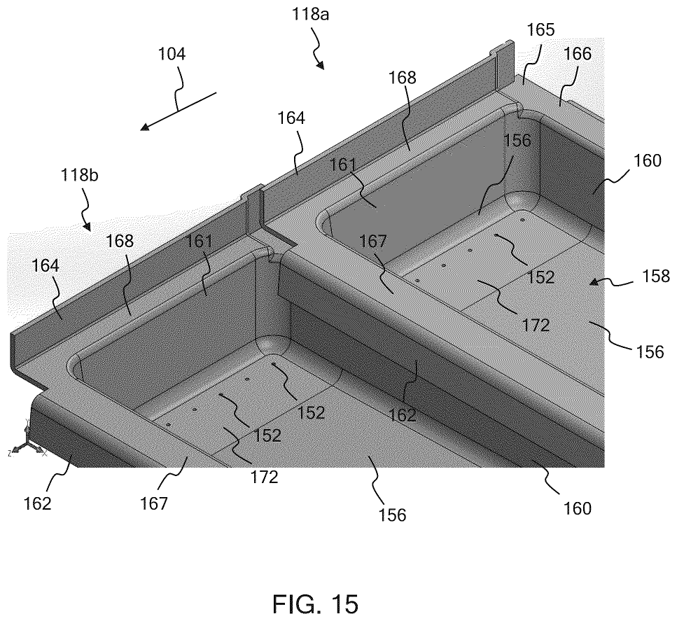

FIG. 6 through FIG. 16 show details of an example embodiment of tray 118. FIG. 6 shows a top perspective view of a tray 118. FIG. 7 shows a top view of tray 118 of FIG. 6. FIG. 8 shows a bottom view of tray 118 of FIG. 6. FIG. 9 shows a side view of tray 118 of FIG. 6. FIG. 10 shows an end view of tray 118 of FIG. 6. FIG. 11 shows a perspective view of a conveyor guide fin 170 of tray 118. FIG. 12 shows an end view of two trays 118 coupled together. FIG. 13 shows a cross section of the end view of two plant trays 118 coupled together of FIG. 12. FIG. 14 shows a partial perspective view of two plant trays 118 coupled together. FIG. 15 shows an expanded partial perspective view of the two plant trays 118 coupled together of FIG. 14. FIG. 16 shows a partial end view of a plant tray 118 and a hood panel 148.

Each tray 118 holds seeds 122 and/or plants 120. Trays 118 are conveyed along conveyor 116, and the seeds 120 and plants 120 in each tray 118 are conveyed along conveyor 116 with trays 118. Trays 118 can take many different embodiments. The details of tray 118 as shown in the figures are exemplary and not meant to be limiting. Any form of tray 118 that will hold seeds 122 and/or plants 120 such that the seeds 122 and/or plants 120 are conveyed along conveyor 116 with trays 118 will be suitable for us with plant growing apparatus 110.

Referring to the embodiment of tray 118 show in FIG. 6 through FIG. 16, tray 118 includes a compartment 119 for holding seeds 122 and plants 120. Compartment 119 of tray 118 has an open top 158. Compartment 119 of tray 118 has an open top 158 so that plants 120 can grow above open top 158 of tray 118, and growing environment 125 will extend into compartment 119 and encompasses seeds 122 and plants 120 in tray 118. Tray 118 has tray length L_{T}, which in this embodiment is about 8 feet long, and tray width W_{T}, which in this embodiment is about 1 foot wide, but this is not meant to be limiting. Trays 118 can have many different length, and heights.

Compartment 119 is bounded by tray bottom 156, front wall 159, rear wall 160, and two side walls 161. Open top 119 is surrounded on its perimeter by a ledge 165. Ledge 165 includes a front ledge portion 167, a rear ledge portion 166, and two side ledge portions 168.

Tray bottom 156 slopes toward either end of tray 118 so that water runs towards side walls 161 to wells 172 located at either end of trays 118, and then drains from trays 118 through a plurality of drain holes 152, as shown in the figures (FIG. 6, FIG. 7, FIG. 14, FIG. 15). In this embodiment, tray bottom 156 slopes from high point 163 towards both side walls 161. In this embodiment, tray bottom 156 slopes from high point 163 that is located approximately halfway between side walls 161, but this is not meant to be limiting. High point 163 can be located at any point along tray bottom between side walls 161. In this embodiment, water that runs past plants 120 or seeds 122 and hits tray bottom 156 runs either in a direction 173 or a direction 174, towards one of the two wells 172 located at either end of tray 118. Once the water reaches a well 172, the water drains from wells 172 out one of the plurality of drain holes 152 (see, for example, FIG. 15 for an expanded view of wells 172 and drain holes 152, not all drain holes 152 are enumerated). In this way, excess water that is not absorbed by seeds 122 or plants 120 is drained from trays 118 so that water does not sit in trays 118. In some embodiments, high point 162 is at or near one of the side walls 161.

Tray 118 also includes a front coupling overhang 162 and a rear coupling overhang 157, as can best be seen in FIG. 12 through FIG. 16. Front coupling overhang 162 and rear coupling overhang 157 are used to keep trays 118 moving together along conveyor 116, and to maintain a spacing S (FIG. 13) between adjacent trays 118. Front coupling overhang 162 is used to removeably couple trays 118 to each other as they travel along conveyor 116. Each front coupling overhang 162 removeably couples a tray 118 to a neighboring tray 118 so that trays 118 move along conveyor 116 as a group. Front coupling overhang 162 extends from front ledge 167 in a direction towards tray bottom 156, as can be seen best in FIG. 12 and FIG. 13. Front ledge 167 and front coupling overhang 162 of a particular tray 118 extend over rear ledge 166 and rear coupling overhang 157 of the neighboring tray 118. This can be best seen in FIG. 12 through FIG. 15 where front ledge 167 and front coupling overhang 162 of tray 118a are positioned over rear ledge 166 and rear coupling overhang 157 of tray 118b. Front coupling overhang 162 of tray 118a hangs onto tray 118b in front of tray 118a, so that when tray 118b moves along conveyor 116 in direction 104, tray 118a is pulled along by tray 118b.

Rear coupling overhang 157 extends from rear ledge 166 in a direction towards tray bottom 156. Rear coupling overhang 157 helps keep trays 118 spaced apart appropriately on conveyor 116. For example when tray 118a is loaded onto conveyor 116, front coupling overhang 162 and front ledge 167 of tray 118a is placed over rear ledge 166 and rear coupling overhang 157 of tray 118b which was previously loaded onto conveyor 116. Front coupling overhang 162 of tray 118a keeps tray 118a moving with tray 118b, and rear coupling ledge 157 of tray 118b keeps trays 118a and 118b spaced apart a distance S on conveyor 116. Thus, front coupling overhang 162 and rear coupling overhang 157 keep trays 118 spaced apart a distance S along conveyor 116 and ensure that as one tray 118 is moved, the following tray 118 moves along conveyor 116 also.

Tray 118 also includes a conveyor guide fin 170 as shown in FIG. 8 through FIG. 13. Conveyor guide fin 170 is used to position trays 118 on conveyor 116, and maintain each tray's position side-to-side on conveyor 116 as trays 118 are conveyed along conveyor 116. Conveyor guide fin 170 is attached to bottom surface 155 of tray 118 (see FIG. 8). Conveyor guide fin 170 extends from bottom surface 155 of tray bottom 156 (see FIG. 8 and FIG. 10), in a direction away from open top 158. In this embodiment each tray 118 has two conveyor guide fins 170, but this is not meant to be limiting. In some embodiments, one conveyor guide fin 170 is used. In some embodiments, more than two conveyor guide fins 170 are used on tray 118.

Tray 118 includes a hood panel guide 164 as shown in the figures. Hood panel guide 164 extends from each side ledge 168 in a direction 183 (FIG. 16) away from tray bottom 156, as shown in the figures, particularly FIG. 16. Hood panel guide 164 is used to keep hood panels 148 from opening and moving away from conveyor 116, as is shown in FIG. 16. Hood panels 148 are flexible and can be folded and moved out of the way for a user to access elements within growing environment 125, as shown in FIG. 4. But it is desirable to keep hood panels 148 flat against trays 118 except when access is desired. Keeping hood panels 148 flat against trays 118 confines growing environment 125 between hood 124 and conveyor 116. Unless access within growing environment 125 is desired, hood panels 148 are kept in a normal unopened position. The normal unopened position of hood panels 148 includes having hood panels 138 extending straight down from hood top 146, with a hood panel lower end 149 to the inside of, and against, a panel guide inner surface 169 of panel guide 164. Hood panel guide 164 keeps hood panel 148 from swinging outwards away from tray 118. In this way panel guide 164 keeps hood panels 148 in a normal position. Keeping hood panel 148 in a normal unopened position helps to confine growing environment 125 between conveyor 116 and hood 124.

It is to be understood that plant growing apparatus 110 can take many different forms and embodiments, and that the details shown and described are examples only and not meant to be limiting. It is to be understood that tray 118, conveyor 116, hood 124, and other parts of plant growing apparatus 110 can take many different forms and embodiments.

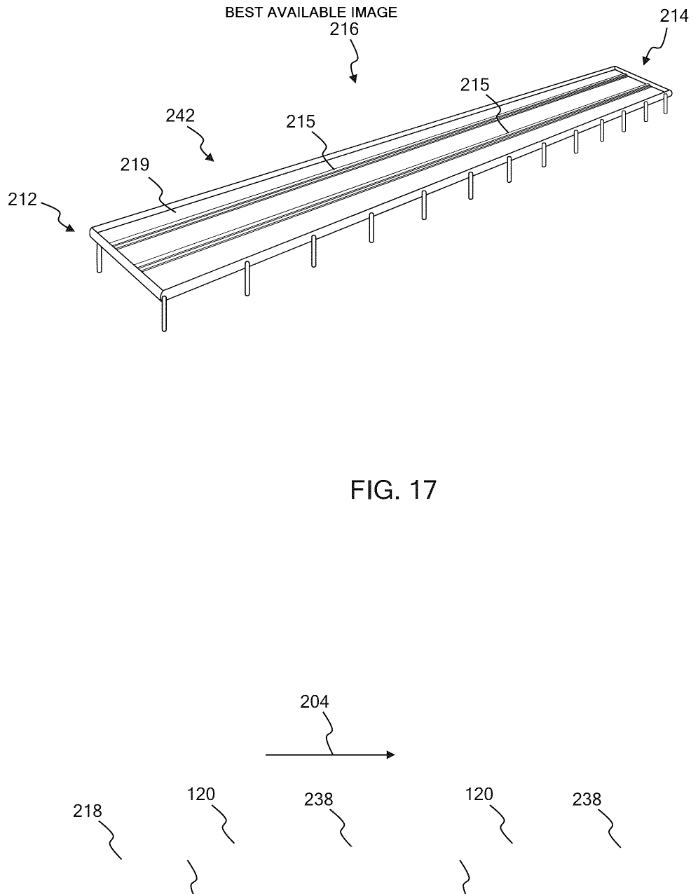

FIG. 17 through FIG. 19 show an embodiment of a conveyor 216 and power trays 238 that can be used with plant growing apparatus 110. Conveyor 216 and trays 238 can be used in place of conveyor 116 and trays 118 of plant growing apparatus 110. FIG. 17 shows a top view perspective of conveyor 216. Conveyor 216 includes a platform 219 and two rails 215. Rails 215 extend along the length of platform 219 from a seed end 212 of conveyor 216 to a harvest end 214 of conveyor 216. Rails 215 sit on top of platform 219 and are used to guide trays along conveyor 216.

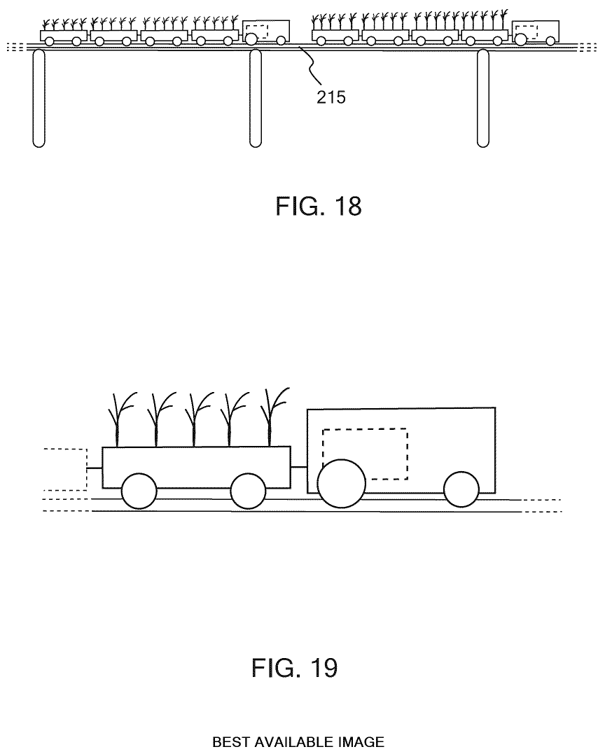

FIG. 18 and FIG. 19 show side views of one or more power trays 238 pulling trays 218 along rails 215. Trays 218 are conveyed along conveyor 216 from seed end 212 to harvest end 214 similar to trays 118 of FIG. 1 through FIG. 5. Trays 218 are loaded with seeds 122 at seed end 212. Seeds 122 sprout into plants 120. Plants 120 are harvested from trays 218 at harvest end 214. Trays 218 are conveyed along conveyor 216 through a growing environment the same or similar to growing environment 125, however, growing environment 125 and hood 124 are not shown in FIG. 17 through FIG. 19 for simplicity of the figures.

Power tray 238 includes an engine 250. Engine 250 powers power trays 238 and causes power tray 238 to move along rails 215. Power trays 238 use engine 250 to move one or more trays 218 along rails 215 from seed end 212 to harvest end 214. In this embodiment power trays 238 pull a string of four trays 218 along rails 215, but this is not meant to be limiting. In some embodiments, power tray 238 pulls more or less trays 218 along rails 215. In some embodiments, power trays 238 push trays 218 along rails 215. As power trays 238 move from seed end 212 to harvest end 214 along rails 215, power trays 238 move—convey—trays 218 from seed end 212 to harvest end 214. Power tray 238 in this embodiment includes front wheels 241, which roll along rail 215, and one or more drive wheel 240. Drive wheel 240 is driven by motor 250. Drive wheel 240 is rotated by motor 250, which moves power tray 238 along rail 215. Trays 218 roll on rail 215 on wheels 246. Trays 218 contain seeds 122 or plants 120 as explained earlier with respect to trays 118.

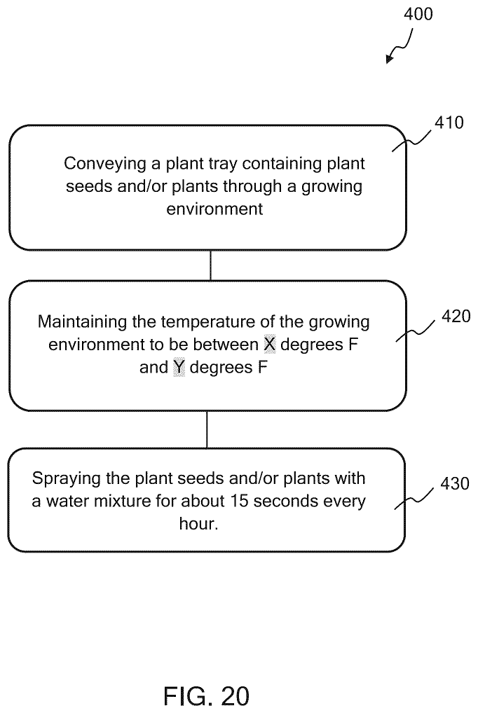

FIG. 20 illustrates method 400 of growing plants. Method 400 includes step 410 of conveying a plant tray containing plant seeds and/or plants through a growing environment. Method 400 also includes step 420 of maintaining the temperature of the growing environment to be between about X degrees F. and Y degrees F. And method 400 also includes step 430 of spraying the plant seeds and/or plants with a water mixture for about 15 seconds each hour.

Method 400 can include many other steps. In some embodiments, method 400 includes the step of conveying a sterilizing tray containing sterilizing equipment through the growing environment alongside the plant tray.

In some embodiments, method 400 includes illuminating the plants and/or seeds with growing light rays.

Some embodiments of plant growing apparatus 110 include one or more than one of the following features, see the accompanying drawings, pages 1-26:
1. Each segment of the conveyor is a standard size—20 ft long and 10 ft wide—and is the “building block” of all systems. The segments attached together and can be from 1 to 13 segments. Conveyor length can be 20 to 260 ft long.
2. The method of moving the trays down the conveyor is now based upon two factors. Each segment of the conveyor (20 ft) is 2″ higher coming downhill from the seeding end to the harvesting end. So, a 13 segment conveyor is 26″ higher at the seed end than at the harvest end. Because the trays are locked together and gain weight (as the fodder grows) by a factor of 10, so that 8 lb. of seed grows into 80 lb of barley fodder. This gain in weight and the downhill orientation provides the power to move the trays along the conveyor. So, the conveyor is powered by gravity.
3. The tray design has changed and are 1.5″ higher in the middle than at the ends. This allows for the tray to drain any excess water and nutrient to the ends of each tray. There is a gutter that catches any runoff which is then routed into the ground or into the sewer.
4. Because the bottom of the tray is higher in the middle than at the ends, keeping the tray oriented on the conveyor (in perfect line) was a difficult problem to resolve. The conveyors rollers are 4″ wide (narrow rollers) and 4 of them run the length of the conveyor. By reorienting the rollers from being parallel to the floor to being parallel to the bottom of the tray, gravity also orients the tray so that it travels straight down the conveyor without any mechanical guidance.
5. All system segments are identical, so to orient the segment to have a downhill 2″ per 20 ft downhill orientation, the columns that support the conveyor (also standard) have been drilled with a set of holes (2″ a part) that can accommodate this downhill requirement.
6. To reduce building costs, and compress the space needed for a large system, the columns can support 2 additional conveyors on top of each other. So, the growing system can come 3 conveyors high (stack) and multiple stacks wide. Our largest system is a 3 high stack, 5 stacks wide—with another 3 high stack, 5 stacks wide—both of the harvest ends point towards each other—and produce 32 tons of food daily.

The accompanying drawings, pages 1-26, illustrate embodiments and features of the growing system invention.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above.

1. A plant growing apparatus comprising:
a conveyor;
and
a plant tray setting on a top side of the conveyor, wherein the conveyor conveys the plant tray from a seed end to a harvest end through a growing environment, and wherein the plant tray comprises a coupling overhang extending from a ledge of the plant tray, wherein the coupling overhang removeably couples the plant tray to a second plant tray.

2. The plant growing apparatus of claim 1 wherein the plant tray comprises a compartment for containing plant seeds and plants which sprout from the plant seeds, the compartment bounded by:
an open top bounded by a ledge;
a tray bottom;
a front wall;
a rear wall;
a first side wall; and
a second side wall.

3. The plant growing apparatus of claim 2, wherein the bottom slopes from a high point located near a center of the compartment towards each of the first side wall and the second side wall.

4. The plant growing apparatus of claim 2, wherein the tray further comprises a hood panel guide extending from a side wall ledge in a direction away from the bottom.

5. The plant growing apparatus of claim 4, wherein the hood panel guide holds a hood panel in a position against an inner surface of the hood panel guide.

6. The plant growing apparatus of claim 2, wherein the tray further comprises a first and a second conveyor guide fin, wherein each of the first and the second conveyor guide fins extend from a bottom surface of the bottom, in a direction away from the open top.

7. The plant growing apparatus of claim 1, further comprising a hood, wherein the hood confines the growing environment between the top side of the conveyor and the hood.

8. The plant growing apparatus of claim 7, wherein the hood comprises:
a hood top; and
hood sides extending from the hood top between the hood and the conveyor, wherein the hood sides comprise a plurality of hood panels of flexible material hanging from the hood top.

9. The plant growing apparatus of claim 8, further comprising a growing light emitter enclosed in the growing environment between the hood and the conveyor, wherein the hood sides reflect growing light rays emitted by the growing light emitter.

10. The plant growing apparatus of claim 1, further comprising a sterilizing tray setting on the top side of the conveyor, wherein the sterilizing tray comprises a sterilizing system, and wherein the sterilizing system sterilizes the growing environment in response to the conveyor conveying the sterilizing tray from the seed end to the harvest end along the top side of the conveyor.

11. The plant growing apparatus of claim 1, further comprising a thermostat, wherein the thermostat maintains the temperature of the growing environment within about 2 degrees Fahrenheit.

12. A plant growing apparatus comprising:
a conveyor;
a plurality of plant trays setting on the conveyor, wherein the conveyor conveys the plurality of plant trays from a seed end to a harvest end through a growing environment;
and
a sterilizing tray setting on the conveyor, wherein the sterilizing tray sterilizes the growing environment in response to the conveyor conveying the sterilizing tray from the seed end to the harvest end through the growing environment.

13. The plant growing apparatus of claim 12, wherein the sterilizing tray comprises a liquid sprayer that sprays sterilizing liquid into the growing environment.

14. The plant growing apparatus of claim 12, wherein the sterilizing tray comprises a sterilizing light emitter that emits sterilizing light into the growing environment.

15. A method of growing plants comprising:
conveying a plant tray containing plant seeds and/or plants through a growing environment;
maintaining the temperature of the growing environment to be between X degrees F. and Y degrees F.; and
spraying the plant seeds and/or plants with a water mixture for about 15 seconds per hour.

16. The method of growing plants of claim 15, further comprising conveying a sterilizing tray containing sterilizing equipment through the growing environment alongside the plant tray.

17. The method of growing plants of claim 15, further comprising illuminating the plants and/or seeds with growing light rays.
